(19) United States
(12) Patent Application Publication
(10) Pub. No.: US 2006/0080191 A1
(43) Pub. Date: Apr. 13, 2006

(54) RETIREMENT PLAN FINANCIAL PRODUCT

(76) Inventor: Paul Hinson, Sugar Land, TX (US)

Correspondence Address: NOVAK DRUCE & QUIGG, LLP, 1300 EYE STREET NW, 400 EAST TOWER, WASHINGTON, DC, 20005, US

(21) Appl. No.: 10/908,419

(22) Filed: May 11, 2005

(51) Int. Cl. G06Q 40/00

(52) U.S. Cl. 705/35

(57) ABSTRACT

A retirement plan financial product includes a long-term disability insurance policy or contract as a component of the assets of the trust underlying the plan. The insurance contract pays benefits into the plan upon the disability of a plan participant. The benefits are treated as income or gain under the plan and are allocated to the participant's account. Benefits are distributable only upon attainment of the participant's normal retirement age.

### CLAIM FOR PRIORITY UNDER 35 U.S.C. § 119(e)

This application claims the benefit of co-pending U.S. Provisional Application Ser. No. 60/000,000, filed on May 13, 2004.

### FIELD OF THE INVENTION

This invention relates generally to financial products and more specifically to retirement savings plan financial products such as defined contribution or so-called “401 (k)” (after the corresponding section of the pertinent Internal Revenue Code) retirement plans. Such plans also include plans established pursuant to sections 403(b) and 457 of the Internal Revenue Code (Title 26, United States Code).

### BACKGROUND OF THE INVENTION

Many different retirement plans exist on the market today. However, the defined contribution or “401 (k)” plan currently is the most popular type of plan for the American worker to save money for retirement.

There are currently over 30 million individual 401 (k) plan participants in the United States. These plans have over one trillion dollars in assets, which exceeds the total assets in all other types of plans combined. Approximately 88% of these plans permit the employee, to a limited extent, to choose and/or modify the particular securities in which the employee's money is invested.

A 401 (k) retirement plan is one that is funded primarily by employee contributions from annual salary or wages, and which also may have an employer matching component whereby the employer will contribute a matching percentage of the employee's annual contribution to the plan, and further may include a discretionary profit-sharing component. A significant benefit of the 401 (k) plan is its tax-deferred nature: not only are contributions deducted from the employee's pre-tax gross income, but gains from the investments in the plan also grow tax-free until such time as withdrawals are made.

Among the advantages of 401 (k) plans are that since the employee does not pay any income tax on the percentage of his/her compensation that is contributed to the plan, such contributions effectively realize an immediate percentage “gain” defined by the employee's current tax bracket (which amount the employee would otherwise have to pay in income tax if the employee took the compensation in cash). Additionally, neither employer matching contributions nor employer discretionary profit-sharing contributions are subject to taxation when made to the plan. Further, the employee typically is able to choose among a number of different investment securities such as mutual stock funds, bond funds, cash management funds, and the like in which to invest the contributed funds, and normally he/she can move funds from one security to another thereby changing the relative percentage contributed to the different funds of the plan on an ongoing basis.

Still further, should the employee separate from his/her employer, unlike a pension or defined benefit plan, the employee's vested 401 (k) funds may be “rolled over” either to a personal IRA (Individual Retirement Account) or to the 401 (k) plan of a new employer.

One problem with current 401 (k) plans occurs when an employee becomes disabled, e.g. as a result of injury or illness, and is no longer able to work either permanently or for an extended period of time. During this period of disability, the employee is not receiving regular compensation and therefore cannot continue to make contributions to the retirement plan from periodic paychecks. In fact, even if the disabled employee had available funds from which to make contributions to the retirement plan, such would normally not be permitted as the disabled employee is not an active worker and therefore would not be eligible to make ongoing contributions.

Of course, many employers provide short term and long term disability insurance for their employees. Such insurance, however, typically provides only a fraction of the income received from the disabled employee's regular job, is usually considered to be taxable income if the employer has paid the insurance premiums on behalf of the employee, and is only payable during the period that the employee is disabled—which by definition is usually at time during which the disabled individual is also incurring significant additional healthcare related expenses. Consequently, such disability insurance does not make up for the loss of expected growth in the employee's retirement plan over the long term caused by disability, which may be tens of thousands of dollars or more depending upon the age of the employee at the time of disability and the expected normal retirement age.

Accordingly, there exists a need for improvements in deferred compensation contribution plans and in particular 401 (k) plans to address the potentially staggering loss caused by a long term disability.

### SUMMARY OF THE INVENTION

The present invention solves the shortcomings of the prior art by providing a novel defined contribution retirement plan financial product that provides a complete retirement benefit to an employee at normal retirement age notwithstanding any long term disability of such employee during the span of his/her working career. The product also is designed to facilitate satisfaction of the fiduciary requirements as outlined in ERISA Section 404(c) (29 U.S.C. § 1104).

In particular, according to one aspect of the invention, a retirement plan financial product is provided that includes a disability insurance contract that is owned by a retirement plan trust and is for the benefit of the retirement plan trust. It insures a participant under the retirement plan against disability from further employment because premiums due under the insurance contract are paid from funds in the trust. The benefits paid under the insurance contract are paid into the trust and further allocated to participants' accounts. Further, the benefits paid under the insurance contract are not distributable to the insured participant until the participant is eligible to receive plan distributions as a result of attaining normal retirement age as defined in the retirement plan.

According to another aspect of the invention, a method is provided to compensate for lost opportunity to contribute pre-taxed money to a deferred taxation retirement plan as a result of disability of a plan participant.

### DETAILED DESCRIPTION OF THE PREFERRED EMBODIMENTS

According to the present invention, a retirement plan financial product includes a long-term disability insurance policy or contract as a component of the assets of the trust underlying the plan. In a preferred embodiment of the invention, the long-term disability policy is structured as a group disability policy, with the group being the participants under the retirement plan.

According to the invention, the owner and beneficiary of the long-term disability insurance policy is the retirement plan trust, and not the individual participants or individual or group trusts set up outside the retirement plan.

Premiums due under the disability insurance contract are paid from funds in the retirement plan trust, and can be contributions from the participants or from the employer.

Benefits paid out by the long-term disability insurance policy are allocated to the account of the disabled participant and treated as income of the trust or as a return on investment, similar to dividends or capital gains received from mutual funds invested under the retirement plan. Thus, the disability benefits are not paid to the disabled participant, but instead are used as a de facto contribution to the retirement plan on behalf of the disabled participant.

In particular, although the disabled participant would not be classified as an active employee and therefore normally would not be eligible to make elective contributions to the retirement plan, in accordance with the present invention the benefits paid under the long-term disability insurance contract are designed to correspond to the elective deferral as well as employer contribution amounts that were being made to the plan by the participant prior to disability. In this manner, the benefit is somewhat analogous to a “waiver of premium” benefit typically provided as a rider to conventional insurance contracts such as life insurance, wherein premiums due under the insurance contract are automatically paid upon the disability of the insured.

Typically, participants have the ability to direct where returns on investment such as dividends or capital gains realized by the retirement plan trust are reinvested. Consequently, in accordance with the invention the disability benefits allocated to the account of the disabled participant in the retirement fund are reinvested in one or more of the investment vehicles available under the plan, such as, e.g., mutual stock funds, bond funds, cash management funds, and the like

According to a preferred embodiment of the invention, the retirement plan financial product may have the following attributes:

1) the disability policy is provided as a guaranteed issue policy, in other words there is no underwriting for insurability;

2) the policy is non-cancelable and is guaranteed renewable to age 65 (or to normal retirement age as may be subsequently defined);

3) the policy is available for standard occupation classes 1-6 as defined by the industry;

4) the policy will provide unisex premium rates;

5) benefits are payable upon elimination periods of 180 days or 365 days;

6) benefits are payable to age 65 (or to normal retirement age as may be subsequently defined);

7) maximum benefits under the policy are indexed to the maximum amount of employee and employer contributions allowed to be contributed to the retirement plan (currently $44,000 per year); and

8) insurance benefits are paid to the retirement plan trust and allocated to the participant's account, and cannot be distributed to the participant until normal retirement age.

Another preferred attribute of the retirement plan financial product according to the present invention is that the insurance contract may be converted from a group contract to an individual contract upon separation of employment by the plan participant. In such manner, the insurance contract will be portable and consequently may be “rolled over” into a new retirement plan as the participant changes jobs, or may be maintained by the participant as a conventional individual disability insurance policy.

The invention having been thus described, it will be obvious to those skilled in the art that the same may be varied in many ways without departing from the spirit and scope of the invention. Any and all such modifications are intended to be included within the scope of the following claims.

What is claimed is:

1. A retirement plan financial product, comprising:
a disability insurance contract that is owned by a retirement plan trust, and is for the benefit of the retirement plan trust, and which insures a participant under the retirement plan against disability from further employment; wherein
premiums due under the insurance contract are paid from funds in the trust;
benefits paid under the insurance contract are paid into the trust and further allocated to participants' accounts; and
benefits paid under the insurance contract are not distributable to the insured participant until the participant is eligible to receive plan distributions as a result of attaining normal retirement age as defined in the retirement plan.

2. The retirement plan financial product according to claim 1, wherein the retirement plan is a defined contribution plan.

3. The retirement plan financial product according to claim 2, wherein the defined contribution plan is a 401 (k) plan.

4. The retirement plan financial product according to claim 2, wherein the defined contribution plan is a 403(b) plan.

5. The retirement plan financial product according to claim 2, wherein the defined contribution plan is a 457 plan.

6. The retirement plan financial product according to claim 1, wherein said disability insurance contract is a group disability contract, with participants in said retirement plan being members of the group.

7. The retirement plan financial product according to claim 6, wherein said disability insurance contract is convertible to an individual disability insurance contract.

8. The retirement plan financial product according to claim 7, wherein said contract is convertible to an individual disability insurance contract upon separation of employment by a plan participant.

9. The retirement plan financial product according to claim 1, wherein premium rates under said contract are unisex in nature.

10. The retirement plan financial product according to claim 1, wherein benefits paid under the contract are indexed in accordance with maximum contribution deferrals allowed by applicable regulation to be made to said retirement plan.

11. The retirement plan financial product according to claim 1, wherein said disability insurance contract is made on a guaranteed issue basis.

12. The retirement plan financial product according to claim 1, wherein said disability insurance contract is renewable to a predefined normal retirement age.

13. The retirement plan financial product according to claim 1, wherein benefits under said disability insurance contract are payable to a predefined normal retirement age.

14. A method of compensating for lost opportunity to contribute pre-taxed money to a retirement plan because of disability, comprising the steps of:
receiving payments of premiums to a disability insurance contract that is owned by a retirement plan trust, is for the benefit of the retirement plan trust, and which insures a participant under the retirement plan against disability from further employment, wherein said payments of premiums are paid from funds in the trust;
paying benefits under the insurance contract into the trust from which they are further allocated to participants' accounts; and wherein
benefits paid under the insurance contract are not distributable to the insured participant until the participant is eligible to receive plan distributions as a result of attaining normal retirement age as defined in the retirement plan.

15. The method according to claim 14, wherein the retirement plan is a defined contribution plan.

16. The method according to claim 15, wherein the defined contribution plan is a 401 (k) plan.

17. The method according to claim 15, wherein the defined contribution plan is a 403(b) plan.

18. The method according to claim 15, wherein the defined contribution plan is a 457 plan.

19. The method according to claim 14, wherein said disability insurance contract is a group disability contract, with participants in said retirement plan being members of the group.

20. The method according to claim 19, wherein said disability insurance contract is convertible to an individual disability insurance contract.

21. The method according to claim 20, wherein said contract is convertible to an individual disability insurance contract upon separation of employment by a plan participant.

22. The method according to claim 14, wherein premium rates under said contract are unisex in nature.

23. The method according to claim 14, wherein benefits paid under the contract are indexed in accordance with maximum contribution deferrals allowed to be made to said retirement plan.

24. The method according to claim 14, wherein said disability insurance contract is made on a guaranteed issue basis.

25. The method according to claim 14, wherein said disability insurance contract is renewable to a predefined normal retirement age.

26. The method according to claim 14, wherein benefits under said disability insurance contract are payable to a predefined normal retirement age.
